(19) United States
(12) Patent Application Publication
(10) Pub. No.: US 2025/0278751 A1
(43) Pub. Date: Sep. 4, 2025

(54) SIMILAR ITEM FORECASTING

(71) Applicant: Target Brands, Inc., Minneapolis, MN (US)

(72) Inventors: MOHAR GUHA, Sunnyvale, CA (US); SAYON MAJUMDAR, San Francisco, CA (US); BO SHEN, Stanford, CA (US); Sanghui Park, San Mateo, CA (US)

(21) Appl. No.: 18/595,160

(22) Filed: Mar. 4, 2024

(51) Int. Cl. G06Q 30/0202

(52) U.S. Cl. CPC G06Q 30/0202

(57) ABSTRACT

A forecasting system is disclosed. The forecasting system may determine that a forecasting model is unable to generate a demand forecast for a selected item. The forecasting system may identify items that are similar to the selected item. The forecasting system may determine model-based forecasts for the similar items. The forecasting system may aggregate the forecasts of the similar items to determine a demand forecast of the selected item. The forecasting system may determine demand forecasts for a plurality of items.

### BACKGROUND

Computer models may require quality training data to be effective. For example, for a computer model to provide an accurate output, the computer model may need to have first been exposed to (e.g., trained on) enough relevant data. Without such data, a computer model may be unable to generate a useful output. Attaining a sufficient quantity of relevant training data can be a challenge. In some instances, data may be scarce, low quality, or difficult to collect. In an example context, computer models may be used to forecast demand, such as demand for an item over time. However, computer models trained and deployed in the context of demand forecasting may also require enough quality data to be effective, and in some instances, attaining such data can be a challenge.

### SUMMARY

Aspects of the present disclosure relate to a system that uses computer models to forecast demand. In examples, the system may identify instances in which the computer models may be incapable of providing an accurate forecast due to a lack of data, such as a lack historical demand data for an item. In such instances, the system may generate a demand forecast for the item based on demand forecasts for similar items.

In a first aspect, a method for forecasting demand is disclosed. The method comprises determining that a forecasting model is unable to generate a demand forecast for a selected item based at least in part on a lack of training data associated with the selected item; determining a set of similar items for the selected item; for each similar item in the set of similar items, applying the forecasting model to determine a respective demand forecast for the similar item; and determining the demand forecast for the selected item by aggregating respective demand forecasts of similar items of the sets of similar items.

In a second aspect, a forecasting system is disclosed. The forecasting system comprises a similarity scoring system; a forecasting model; and an orchestrator; wherein the orchestrator is configured to: determine, for a selected item, whether the forecasting model is configured to generate a demand forecast for the selected item; in response to determining that the forecasting model is not configured to generate the demand forecast for the selected item based on a lack of training data associated with the selected item, determine a set of similar items for the selected item by using the similarity scoring system; for each similar item in the set of similar items, apply the forecasting model to determine a respective demand forecast for the similar item; and determine the demand forecast for the selected item by aggregating respective demand forecasts of similar items of the set of similar items.

In a third aspect, a demand forecasting tool is disclosed. The demand forecasting tool comprises a processor; and memory storing instructions that, when executed by the processor, cause the demand forecasting tool to: determine that a forecasting model is unable to generate a demand forecast for a selected item based at least in part on a lack of training data associated with the selected item; determine a set of similar items for the selected item; for each similar item in the set of similar items, apply the forecasting model to determine a respective demand forecast for the similar item; and determine the demand forecast for the selected item by aggregating respective demand forecasts of similar items of the sets of similar items.

### BRIEF DESCRIPTION OF THE DRAWINGS

FIG. 1 illustrates an example network environment in which aspects of the present disclosure may be implemented.

FIG. 2 illustrates a block diagram of an example architecture of a forecasting system.

FIG. 3 is a flowchart of an example method for forecasting demand for a plurality of items.

FIG. 4 illustrates a schematic diagram of inputs to a nearest neighbor item forecast and outputs of the nearest neighbor item forecast.

FIG. 5 is a flowchart of an example method for applying a nearest neighbor forecast.

FIG. 6 is a flowchart of an example method for applying a category forecast.

FIG. 7 is a flowchart of an example method for applying one or more forecasting techniques.

FIG. 8 illustrates an example user interface associated with a forecasting system.

FIG. 9 illustrates a block diagram of an example computing environment.

### DETAILED DESCRIPTION

Aspects of the present disclosure relate to a system for forecasting demand, such as item demand over time. In some instances, demand over time is a complex stochastic process dependent on many variables, some of which may be unknown or unknowable. Given this complex stochastic nature of forecasting demand, computer models may be useful. Because computer systems can process, store, and exchange data in ways that go far beyond what humans can perform, computer models may forecast demand using methods that are distinct from any related human methods for forecasting data. That is, modeling complex stochastic processes, such as demand over time, is an endeavor that goes to the core of computer technology. Furthermore, as a result of computers' unique processing capabilities, computer models may ultimately derive much more accurate demand forecasts at much faster speeds than other techniques for forecasting demand. Thus, a demand forecasting system may use computer models; however, the effectiveness of such a forecasting system may be dependent on having sufficient relevant data to train the computer models.

In example aspects, the forecasting system disclosed herein may forecast demand for a plurality of items. For an example item, the forecasting system may forecast the demand for the example item at each of a plurality of locations (e.g., a plurality of individual stores or regions) or may forecast the demand for the example item generally (e.g., across all locations). To do so, the forecasting system may apply one or more models that are trained on historical demand data associated with the item, which may include historical sales for the item. Accounting for this historical demand data and other considerations, the models may output a demand forecast.

In some instances, however, there may be some items, such as new items, for which there is not sufficient training data. For example, there may not be sufficient historical demand data associated with the items. Given this deficiency, computer models may not accurately forecast demand for these items. Nevertheless, according to aspects of the present disclosure, the forecasting system may generate forecasts for such items. To do so, the forecasting system may, in some embodiments, use model-based forecasts of similar items.

In example aspects, for an item without sufficient associated historical demand data, the forecasting system may apply a nearest neighbor forecast. For example, the forecasting system may identify similar items by applying one or more techniques for determining a similarity score between items. Having identified similar items, the forecasting system may determine forecasts for the similar items and then combine these forecasts to generate a forecast for the item. As part of combining the forecasts for the similar items, the forecasting system may alter the forecasts to account for differences between items and may weigh some item forecasts more than others.

In example aspects, the forecasting system may apply one or more forecasting techniques for an item. For example, if there is sufficient training data for existing models to generate a demand forecast for an item, then the forecasting system may use existing models; if not, the forecasting system may generate a demand forecast by applying a nearest neighbor forecast to aggregate model-based demand forecasts of similar items; if there are an insufficient number of similar items, then the forecasting system may generate a demand forecast for the selected item using an aggregation of model-based demand forecasts of items belonging to a common category as the selected item. In some embodiments, the forecasting system may perform such operations for a plurality of items.

Aspects of the present disclosure may provide various advantages. For example, the forecasting system may determine model-based demand forecasts for a plurality of items, even though one or more of the items may not be associated with historical demand data, thereby providing a solution to the technical problem of data scarcity when using computers to model demand. Yet still, the forecasting system is flexible, accommodating various types of underlying models, thereby providing a system in which models may be easily updated, retrained, or replaced.

Yet still, aspects of the present disclosure enable more accurate demand forecasts by borrowing demand forecasts from similar items. For example, in some instances, a computer model-based forecasting approach may still be implemented by using model-derived demand from similar items. Furthermore, in some embodiments, by applying a tiered approach for demand forecasting, the forecasting system may execute a forecasting process that is best for each item, thereby resulting in more accurate demand forecasts for items without associated training data without comprising the quality of forecasts for items that do have associated training data. Further, as data associated with an item accumulates, the forecasting system may change a way in which demand is forecast for that item. Additionally, by causing each of a model forecast, a nearest neighbor forecast, and a category forecast to output forecasts having a common format (e.g., a common table schema), the way in which demand is forecast for any particular item may be abstracted from a forecast consumer, thereby ensuring compatibility of the forecasting system with various downstream forecast consumers.

As will be apparent, these are only some of the advantages that may be provided by aspects of the present disclosure. Further, according to some embodiments of the present disclosure, one or more of these advantages may not present.

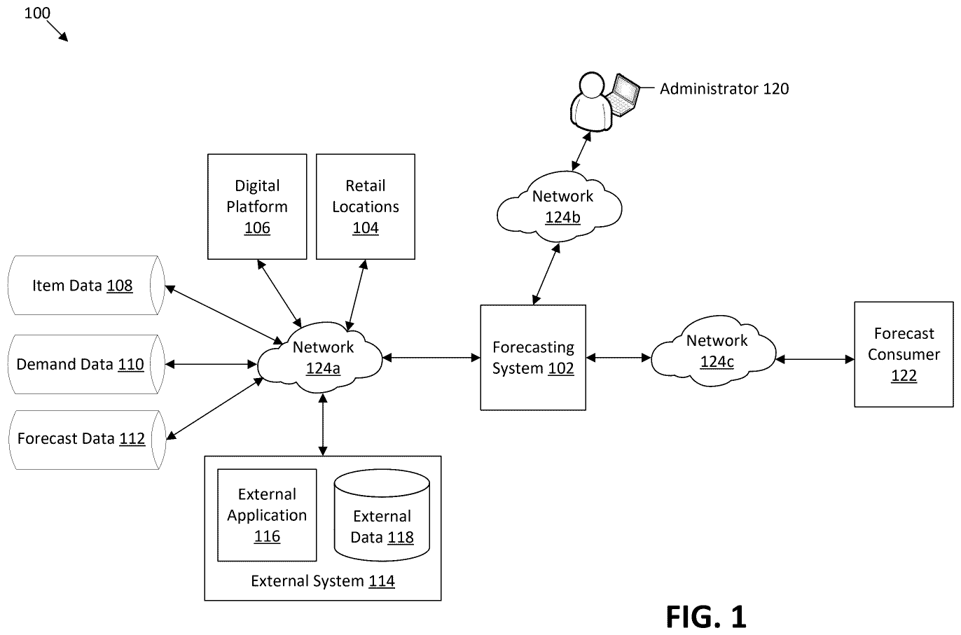

FIG. 1 illustrates an example network environment 100 in which aspects of the present disclosure may be implemented. In the example shown, the environment 100 includes a forecasting system 102, retail locations 104, a digital platform 106, item data 108, demand data 110, forecast data 112, an external system 114, an administrator 120, a forecast consumer 122, and networks 124a-c. In some embodiments, one or more of the components illustrated in FIG. 1 may be associated with a common entity. For example, one or more of the components illustrated in FIG. 1 may be part of an information system of an organization or may be communicatively coupled with aspects of an information system of an entity. In some embodiments, the entity is a retailer.

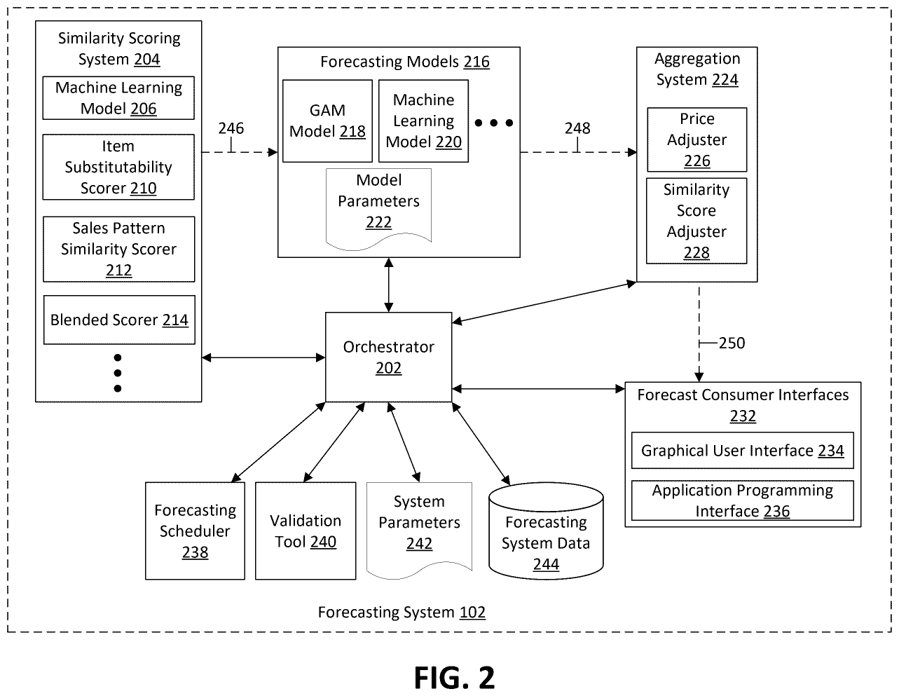

The forecasting system 102 may be a collection of hardware and software configured to forecast demand. In some embodiments, the forecasting system 102 may use computer models to generate demand forecasts for items. In examples, the items are offered for sale by a retailer. In some embodiments, aspects of the forecasting system 102 may be distributed across different computing environments. In some embodiments, the forecasting system 102 may receive data from one or more of the components 104-118, may receive a configuration from the administrator 120 or the forecast consumer 122, and may output demand forecast to the forecast consumer 122. An example architecture of the forecasting system 102 is illustrated and described in connection with FIG. 2.

The retail locations 104 may be one or more physical locations associated with a retailer. In some embodiments, the forecasting system 102 may generate demand forecast for a location or group of locations of the retail locations 104. In some instances, a customer may purchase or pickup an item from a retail location of the retail locations 104, which may be registered as demand for that item from that retail location. In some instances, an item may be shipped from a retail location of the retail locations 104, which may be registered as demand for that item, and may or may not be registered as demand at that location. The retail locations 104 may include stores, warehouses, sortation centers, manufacturing facilities, shipping hubs, offices, or other locations that may be used by an entity associated with components of FIG. 1. In some embodiments, the retail locations 104 may be divided into groups, such as groups based on geography or location type. In some embodiments. the retail locations 104 may include computing systems via which the retail locations 104 may transfer data to and from other components of FIG. 1.

The digital platform 106 may include computer systems that can receive or track demand for items. For example, the digital platform 106 may include one or components that facilitate the purchasing of items. In some embodiments, the digital platform 106 includes a website, such as website of a retailer or a website communicatively coupled with a digital retailer system. In some embodiments, the digital platform 106 may include a mobile application.

The item data 108 may include data related to items associated with a retailer. For example, the items may be sold by the retailer. In some embodiments, the item data 108 may include data for items for which forecasts are generated by the forecasting system 102. In some embodiments, for a given item, the item data may include one or more of the following: an item name; an item price; an item inventory; an item vendor; one or more item images; one or more item attributes; seasonal characteristics of the item; one or more locations associated with the item; one or more classifications of the item; an indication of whether the item is a new item; or other data associated with the item. In some embodiments, the forecasting system 102 may use data of the item data 108 to forecast item demand and to determine item similarities.

The demand data 110 may include historical demand data for items, such as items of the item data 108. In some embodiments, the historical demand data may include historical sales. In some embodiments, the demand data 110 may include a demand data for an item at a particular location or group of locations. For example, the demand data 110 may include historical demand data for an item at a location over time, and the demand data 110 may also include historical demand data over time for the item across a supply chain. In some embodiments, the demand data 110 may include demand data generated at the digital platform 106, which may include sales at a website. In some embodiments, the demand data 110 may include synthetic data that is derived at least in part from historical sales data.

The forecast data 112 may include current and past forecasts for items, such as items of the item data 108. The forecast data 112 may be generated by the forecasting system 102. In some embodiments, the forecast data 112 may be compared with the demand data 110 to determine an accuracy of the forecasting system 102.

The external system 114 may include data, software, hardware, or infrastructure that may be communicatively coupled with the forecasting system 102. In the example shown, the external system 114 includes an external application 116 and external data 118. The external application 114 may be, for example, a software, platform, or infrastructure service that is useable by the forecasting system 102 to manage or process data. The external data 118 may include a remote data storage service.

The administrator 120 may be a person or system that configures aspects of the forecasting system 102. For example, the administrator 120 may be an engineer that updates the forecasting system 102, deploys the forecasting system 102, updates a parameter of a configuration file of the forecasting system 102, updates a hyperparameter for a model or process of the forecasting system 102, or performs other operations in connection with the forecasting system 102.

The forecast consumer 122 may be a system or person that receive forecasts from the forecasting system 102. In some embodiments, the forecast consumer 122 may be part of an inventory management system or a supply chain management system. In some embodiments, the forecast consumer 122 may be part of the digital platform 106 or one or more of the retail locations 104. In some embodiments, the forecast consumer 122 may, in response to receiving a forecast from the forecasting system 102, automatically adjust an inventory level for one or more items based on data of the forecast. In some embodiments, the forecast consumer 122 may be a web application that includes a graphical user interface (GUI). The GUI may include visualizations of data received from the forecasting system 102, and the GUI may include selectable input fields for providing data to the forecasting system 102. In some embodiments, a user may query the forecasting system 102 to generate a demand forecast by using components of the GUI. In some embodiments, the forecast consumer 122 may access the item data 108, the demand data 110, or the forecast data 112. Although the example of FIG. 1 depicts a single forecast consumer 122, the forecasting system 102 may be coupled with a plurality of forecast consumers, each of which may be a different type of system or may be a common type of system.

FIG. 2 illustrates a block diagram of an example architecture of the forecasting system 102. In the example shown, the forecasting system 102 includes an orchestrator 202, a similarity scoring system 204, forecasting models 216, an aggregation system 224, forecast consumer interfaces 232, a forecasting scheduler 238, a validation tool 240, system parameters 242, and forecasting system data 244. Furthermore, the example of FIG. 2 illustrates aspects of example operations 246-250 that may be performed by the forecasting system 102 as part of applying a nearest neighbor forecast. The forecasting system 102 may include more or fewer components than those illustrated in connection with FIG. 2. Furthermore, the arrangement of components of the forecasting system 102 may vary across embodiments. In some embodiments, components of the forecasting system 102 may be distributed across different computing platforms. In some embodiments, the forecasting system 102 may use components depicted in FIG. 2 to apply various techniques for determining item forecasts, as is further described below.

The orchestrator 202 may control execution of operations by other components of the forecasting system 102. In some embodiments, the orchestrator 202 may ensure that data having an expected format is exchanged between components. The orchestrator 202 may be responsive to inputs from systems external to the forecasting system 102. In some embodiments, the orchestrator 202 may use coordinator flags to control when operations of components of the forecasting system 102 are performed.

The similarity scoring system 204 may determine similarity scores between items. For example, the similarity scoring system 204 may determine a similarity score between a selected item and each item of a plurality of other items. In some instances, the higher the similarity score between items, the higher the degree of similarity. In some embodiments, the similarity scoring system 204 may generate a mapping that represents a plurality of similarities among a plurality of items. For example, the mapping may be a 2-dimensional array with items representing indices and the values representing a similarity score between items. To determine similarities, the similarity scoring system 204 may use one or more of machine learning models 206, an item substitutability scorer 210, a sales pattern similarity scorer 212, a blended scorer 214, or different method for determining similarity.

The machine learning model 206 may be a model configured to determine item embeddings. For example, for a given item, the machine learning model 206 may receive input data associated with the item, such as an item name, one or more item attributes, one or more item categories, an item price, an item demand history, or other data associated with the item. Based on learned weights and the item attributes, the machine learning model 220 may generate and output embeddings for the items. In some embodiments, embeddings generated for two items may be compared (e.g., using cosine similarity or other techniques) to determine a similarity between the two items. In some embodiments, the machine learning model 206 is a neural network. In some embodiments, the machine learning model 206 is a transformer-based model. In some embodiments, the machine learning model 206 includes a plurality of machine learning models.

The item substitutability scorer 210 may determine a similarity score between items based on the degree to which the items may be substituted for one another. There may be various techniques to determine the item substitutability. For example, the degree to which items may be substitutable may depend on one or more of historical sales data, item characteristic similarity, simulations in which items are added or removed, administrator input, or other techniques.

The sales pattern similarity scorer 212 may determine a similarity score between items based on similarities in their respective sales patterns. For example, if historical sales for two items exhibit similar trends (e.g., increasing or decreasing at certain times of the year, in response to certain promotions, or in response to certain economic conditions), then the items may be determined to be similar, whereas if the two items have different sales patterns, then the items may be determined to be different. As another example, if the sales of two items have a similar volume (e.g., high volume or low volume items), then the items may be determined to be similar. In some embodiments, one item may have more associated historical data than another item, such as a longer period of sales data than the other item. In such instances, the sales pattern similarity scorer 212 may only compare periods for which the sales data overlap, or the sales pattern similarity scorer may scale (e.g., by extrapolating or condensing) sales data of one of the items so that the sales patterns may be compared.

The blended scorer 214 may use a combination of techniques to determine item similarity. For example, the blended scorer 214 may use a weighted combination of outputs from one or more of the machine learning model 206, the item substitutability scorer 210, or the sales pattern similarity scorer 212 to determine similarity scores for items.

The forecasting models 216 may include one or more computer models for forecasting item demand. In the example shown, the forecasting models 216 include a general additive mixed (GAM) model 218 and a machine learning model 220. Additionally, the forecasting models 216 may include more models than those illustrated in the example of FIG. 2.

In some embodiments, each of the GAM model 218 and the machine learning model 220 may forecast demand for an item based on a plurality of item features. In examples, the item features may include one or more features from the item data 108. The architecture of the GAM model 218 and the machine learning model 220 may differ. For example, the machine learning model 220 may be a neural network. In some embodiments, the machine learning model 220 includes the GAM model 218. The model parameters 222 may be values that are used during training or inference of one or more of the GAM model 218 or the machine learning model 220. In some embodiments, the parameters 222 may include hyperparameters.

The GAM model 218 and the machine learning model 220 may be a plurality of models. For example, the GAM model 218 may include a plurality of location-specific models and may include a model for a group of locations (e.g., for a full supply chain). Thus, when forecasting demand for an item, a location-specific model may be executed to forecast item demand at a particular location, and a chain-level model may be applied to determine an overall item demand forecast. As another example, the GAM model 218 or the machine learning model 220 may include item-specific forecasting models. For example, to determine an item forecast for a first item, the forecasting system 102 may use a first GAM model to generate a first demand forecast for the first item, and the forecasting system 102 may use a second GAM model to generate a second demand forecast for a second item. In such an embodiment, an item-specific model may be trained using historical demand data for the item. In some embodiments, the forecasting models 216 may be associated with a list of items for which the forecasting models 216 are trained to generate a demand forecast. In some embodiments, one or more of the GAM model 218 or the machine learning model 220 may be configured to generate a demand forecast at a particular time or a range of times.

The aggregation system 224 may be configured to combine different item forecasts into a single forecast. For example, as part of applying a nearest neighbor forecast to determine a forecast for an item, the forecasting system 102 may aggregate forecasts from items that are similar to an item. In some embodiments, this aggregation may include multiple steps. In the example shown, the aggregation system 224 includes a price adjuster 226 and a similarity score adjuster 228.

The price adjuster 226 may alter a forecast of a similar item based on a price difference. If a first item is determined to be sufficiently similar to a second item, such that a demand forecast of the first item is used in part to determine a forecast of the second item, and if the there is a difference in price between the first and second item, then the price adjuster 226 may account for this difference. For example, if the price of the first item is higher than the price of the second item, then the price adjuster may increase the forecasted demand of the first item that may be used as part of determining a forecast for the second item. Conversely, if the price of the first item is lower than the price of the second item, then the price adjuster 226 may decrease the forecasted demand of the first item that may be used as part of determining a forecast for the second item. In some embodiments, the price adjuster 226 includes an application of a piece-wise continuous log-linear function to adjust for price.

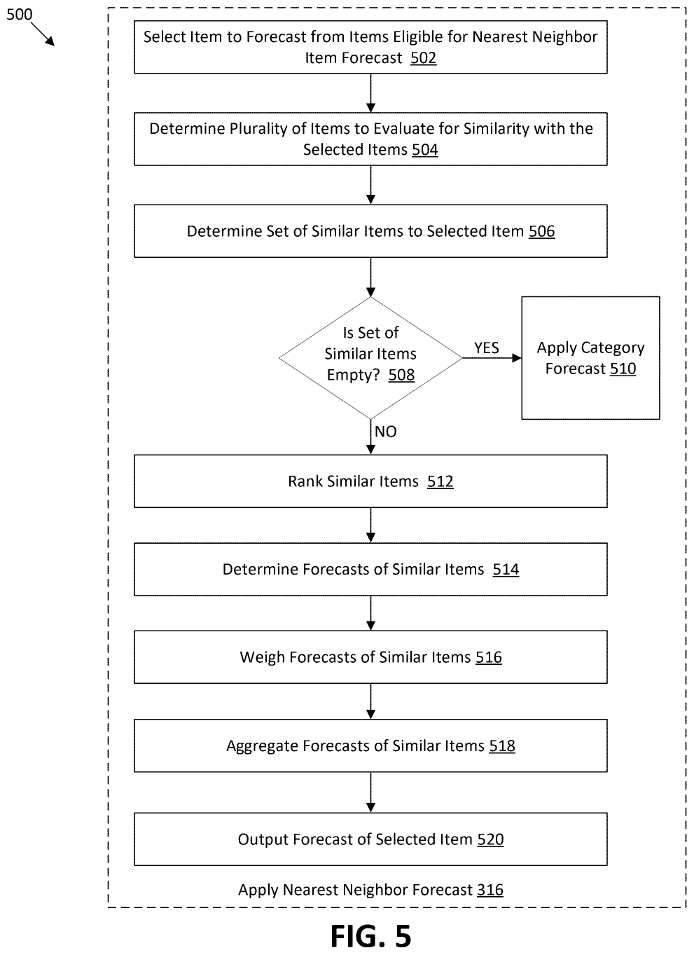

When aggregating forecasts of similar items, the similarity score adjuster 228 may apply a weight to an item forecast based on its similarity to an item that is being forecasted. In some embodiments, the similarity score adjuster 228 may apply a greater weight to items that are more similar and a lesser weight to items that are less similar. Example aspects of the aggregation system 224 are further described below in connection with FIG. 5.

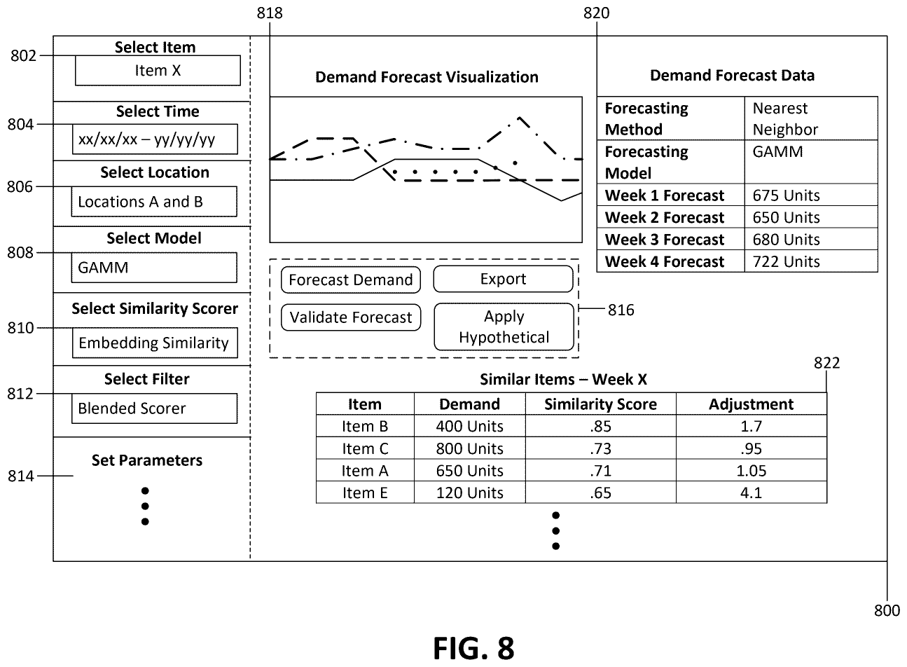

The forecast consumer interfaces 232 may include interfaces for interacting with systems that receive demand forecasts from the forecasting system 102, such as the forecast consumer 122. In the example shown, the forecast consumer interfaces 232 include a GUI 234 and an application programming interface (API) 236. In some embodiments, the GUI 234 may be part of an application that is provided by the forecasting system 102 or that is communicatively coupled with the forecasting system 102. An example of the GUI 234 is illustrated and described in connection with FIG. 8.

The API 236 may provide one or more functions of the forecasting system 102 to other applications. For example, API 236 may enable an application to query the forecasting system 102 for a forecast of an item. Furthermore, in some embodiments, the API 236 may provide one or more subfunctions, such operations performed by the similarity scoring system 204 or the forecasting models 216, to other applications.

The forecasting scheduler 238 may determine a time at which demand forecasts are generated. In some embodiments, the forecasting scheduler 238 may include a load balancer that distributes computations of components of the forecasting system 102 across different computing systems. In some embodiments the forecasting scheduler 238 identifies one or more items or batches of items for which to determine a demand forecast.

The validation tool 240 may identify and monitor differences between demand forecasts produced by the forecasting system 102 and actual demand. For example, the validation tool 240 may compare historical demand forecasts for an item with historical sales for the item. In some embodiments, the validation tool 240 may determine a cause of a difference between a demand forecast and an actual demand value. For instance, for the situation in which the forecasting system 102 generates a demand forecast by applying a nearest item forecast, the forecasting system 102 may identify a degree to which the forecasting models 216 contributed to the difference and a degree to which the similarity scoring system 204 contributed to the difference. In some embodiments, the forecasting system 102 may output reports generated by the validation tool 240 to external systems.

The system parameters 242 may include configurations for the forecasting system 102. Example system parameters 242 may include a data table schema that is used for outputting demand forecasts. Other example parameters may include a selection of one or more scoring components of the similarity scoring system 204 or a selection of one or more of the forecasting models 216. For example, the selection of which component of the similarity scoring system 204 to use or the selection of which forecasting model to use may be based on a configuration in the system parameters 242.

The forecasting system data 244 may include one or more demand forecasts generated by the forecasting system 102 and may include other data useable by the forecasting system data 244.

The operations 246-250 illustrate example aspects of applying a nearest neighbor forecast. The forecasting system 102 may use the similarity scoring system 204 to determine similarity scores between a selected item and a plurality of items. Furthermore, the forecasting system may determine a set of items that are sufficiently similar to the selected item. As indicated by the operation 246, the forecasting system 102 may use the forecasting models 216 to determine demand forecasts for the set of similar items. As indicated by the operation 248, the forecasting system 102 may use the aggregation system 224 to generate a demand forecast for the selected item by aggregating demand forecasts corresponding to items of the set of similar items. As indicated by the operation 250, the forecasting system 102 may use the forecast consumer interfaces 232 to output the demand forecast for the selected item to a forecast consumer. Aspects of applying a nearest neighbor item forecast are further described below in connection with FIG. 5.

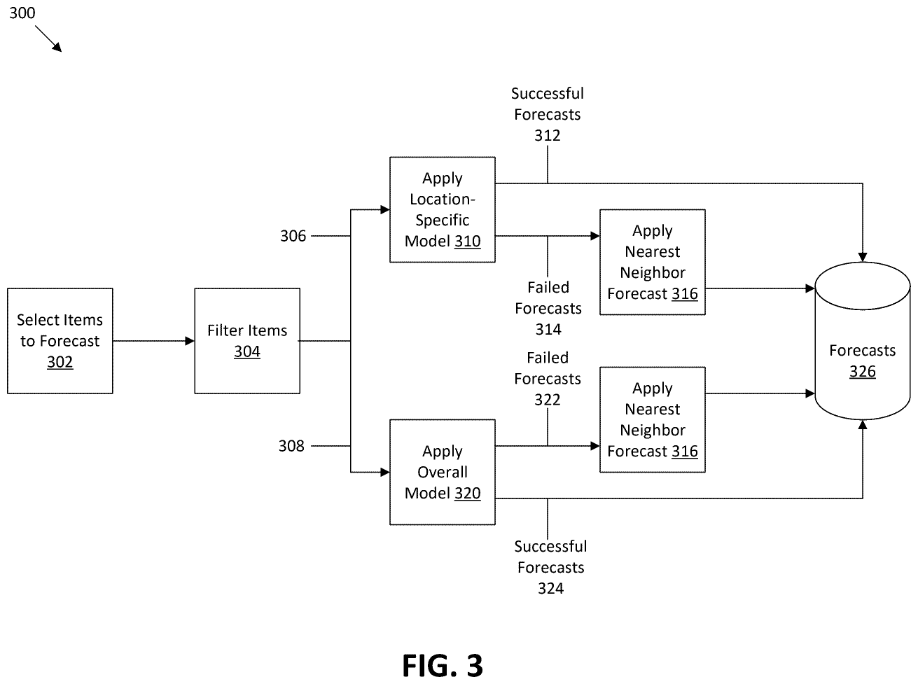

FIG. 3 is a flowchart of an example method 300 that may be performed by the forecasting system 102. In the example of FIG. 3, the forecasting system 102 may apply different forecasting techniques to generate demand forecasts for a full catalog of items offered by a retailer. Furthermore, the forecasting system 102 may generate both location-specific and overall demand forecasts for an item.

In the example shown, the forecasting system 102 may select a plurality of items for which to generate a demand forecast (step 302). The plurality of items may be all the items that the forecasting system 102 can forecast. In some embodiments, the plurality of items may be all items offered for sale by a retailer. In some embodiments, the plurality of items may be a subset of items offered by a retailer. For example, the plurality of items may be items belonging to a particular category of items. In some embodiments, the plurality of items is based on a selection of an item universe input by an administrator or a forecast consumer.

In the example shown, the forecasting system 102 may filter items (step 304). For example, the forecasting system 102 may apply one or more filters to the plurality of items selected at the step 302, thereby generating a filtered subset of items. In some examples, the one or more filters may include filters related to item attributes or categories. In some examples, the one or more filters may relate to sales patterns (e.g., fast-selling items, slow-selling items, holiday items, summer items, etc.).

As indicated by the elements 306-308, the forecasting system 102 may generate different demand forecasts for the items. For example, as indicated by the element 306, for demand forecasts for items at one or more specific locations, the forecasting system 102 may apply a location-specific demand forecasting model (step 310). As another example, as indicated by the element 308, for forecasts of overall demand for an item, the forecasting system may apply an overall forecasting model (step 320). In some embodiments, for a given item, one or more location-specific demand forecasts may be generated and an overall demand forecast may be generated, resulting in a plurality of demand forecasts for the item, each of which may have a different downstream use.

In the example shown, the forecasting system 102 may apply a location-specific model (step 310). For example, the forecasting system 102 may apply one or more of the GAM model 218 or the machine learning model 220, which may be configured to generate an item-specific, location-specific demand forecast. The forecasting system 102 may apply the location-specific forecasting model for a plurality of items. In some embodiments, for a given item, the forecasting system 102 may apply a plurality of location-specific forecasting models to generate a plurality of location-specific forecasts, each of which may be associated with a different location or set of locations.

In some instances, the location-specific forecasting model may be unable to generate a demand forecast for an item. For example, the model may not have sufficient data for an item and therefore may not be trained to produce a demand forecast for the item. For example, if the item is a new item, then the location-specific forecasting model may be unable to determine a demand forecast for that item. Additionally, there may be other reasons for which the location-specific forecasting model may be unable to generate a demand forecast for an item (e.g., an unavailability of the model or data associated with the item that may be incompatible with the model).

As indicated by the element 312, the forecasting system 102 may provide demand forecasts for items that were successfully generated by the location-specific model to the forecast 326. As indicated by the element 314, the forecasting system 102 may, for items for which the location-specific model was unable to generate a forecast, apply a nearest neighbor item forecast.

The forecasts 326 may be a database with demand forecasts. In some embodiments, the forecasts 326 may be part of, or communicatively coupled with, the forecast data 112 or the forecasting system data 244.

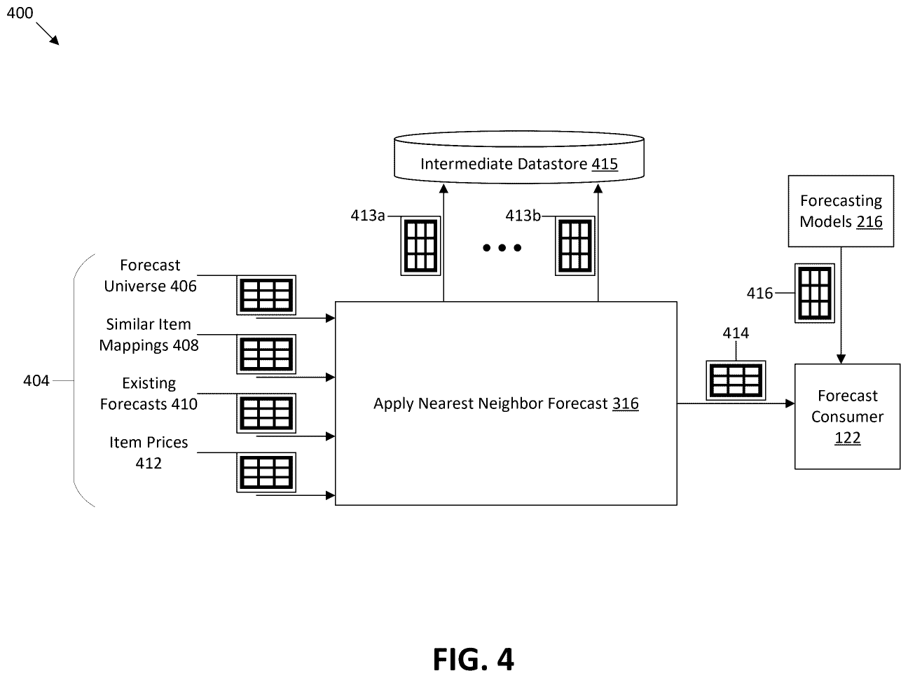

In the example shown, the forecasting system 102 may apply a nearest neighbor forecast (step 316). For example, the forecasting system 102 may apply the nearest neighbor forecast to generate location-specific forecasts of items for which the location-specific models were unable to generate a forecast at step 310. By applying the nearest neighbor forecast, the forecasting system 102 may generate a demand forecast for an item based on forecasts of similar items. Example aspects of the nearest neighbor forecast are further described below in connection with FIGS. 4-5. After applying the nearest neighbor forecast, the forecasting system 102 may provide the generated forecasts to the forecasts 326.

In the example shown, the operations 320-324 may be similar to the operations 310-314, except that, whereas the operations 310-314 involve generating location-specific demand forecasts, the operations 320-324 involve generating overall demand forecast, which may be demand forecasts for an item across an entire supply chain.

For example, the forecasting system 102 may apply an overall forecasting model, which may be one or more of the GAM model 218 or the machine learning model 220, for each of a plurality of items to determine a plurality of overall demand forecasts. However, in some instances, the forecasting system 102 may be unable to generate an overall demand forecast for each item. For example, some items may not have sufficient associated data to generate the demand forecast. For example, the forecasting system 102 may be unable to generate a demand forecast for new items or items with insufficient associated historical demand data. Additionally, there may be other reasons for which the forecasting system 102 is unable to generate a demand forecast.

As indicated by the element 322, the forecasting system 102 may provide data related to items for which an overall forecast failed to the nearest neighbor item forecast. At the step 316, the forecasting system 102 may apply the nearest neighbor forecast to determine an overall forecast for an item based on overall forecasts for items that are similar to the item. As indicated by the example of FIG. 3, the nearest neighbor item forecast may be used to generate both location-specific demand forecasts and to generate overall demand forecasts. The forecasts generated by the nearest neighbor forecast may be provided to the forecasts 326. Further, as indicated by the element 324, overall forecast that were successfully generated at the step 320 may be provided to the forecast 326.

FIG. 4 illustrates a schematic diagram of inputs to the nearest neighbor item forecast and outputs of the nearest neighbor item forecast. FIG. 4 illustrates an application of the nearest neighbor item forecast 316. As depicted in the example of FIG. 3, the nearest neighbor item forecast may be applied to determine both location-specific demand forecasts and to determine overall demand forecasts. The application of the nearest neighbor item forecast 316 of FIG. 4 may represent either a determination of a location-specific demand forecast or an overall demand forecast for one or more items.

The forecasting system 102 may provide a plurality of inputs 404 to the nearest neighbor item forecast. In the example shown, the inputs 404 include a forecast universe 406, similar item mappings 408, existing forecasts 410, and item prices 412. In some embodiments, one or more of the inputs 404 may be formatted as a table. For example, one or more of the inputs 404 may be a HIVE table. In some embodiments, the expected schema of the inputs 404 may depend on a parameter setting in the forecasting system 102. In some embodiments, one or more of the inputs 404 may include data from one or more of the item data 108, demand data 110, or forecast data 112 of FIG. 1. Although depicted as inputs in the example of FIG. 4, the forecasting system 102 may, in some instances, determine at least some of the data in the inputs 404 as part of applying the nearest neighbor forecast.

The forecast universe 406 may include data for one or more items for which demand is to be forecasted and data for potentially similar items to the forecasted items. The similar item mappings 408 may include similarity scores between items. The existing forecasts 410 may include a plurality of forecasts generated by the forecasting models 216. For instance, whereas the nearest neighbor item forecast may be applied to items for which a forecast was unable to be generated, the existing forecast 410 may include forecasts that were successfully generated by the forecasting models 216. For a given item, the existing forecasts 410 may include a plurality of forecasts (e.g., one or more location-specific forecasts and an overall forecast). The item prices 412 may include prices for items. The item price may be the price at which an item is sold by a retailer. The item prices 412 may include changes to item prices over time. The item prices 412 may include changes based on promotions or other temporary price changes. A given item may be associated with a plurality of prices (e.g., a production price, a markup amount, a price at a first location, a price at a second location, an on-sale price, etc.).

As illustrated by the example of FIG. 4, the nearest neighbor item forecast may receive the inputs 404 and based on one or more of the inputs 404, the nearest neighbor item forecast may generate a demand forecast. An example operation of the nearest neighbor item forecast is further described below in connection with FIG. 5.

In some embodiments, the nearest neighbor item forecast may output intermediate results 413a-b. In some embodiments, the intermediate results 413a-b may include forecasts for some but not all of the items to forecast. In some embodiments, the intermediate results 413a-b may include partial demand forecasts for an item (e.g., forecasts that do not consider all locations or all potentially similar items). In some embodiments, the results 413b may include incrementally more data (e.g., more forecasts for items or more complete forecast) than the results 413a. In some embodiments, the intermediate results 413a-b are tables that have a format (e.g., a schema) that matches an output from other forecasting models. In the example shown, the intermediate tables 413a-b are output to the intermediate datastore 415, from which the forecasting system 102 may, in some embodiments, retrieve the intermediate tables 413a-b and then provide data from the intermediate tables 413a-b to downstream systems.

In the example shown, the nearest neighbor item forecast may output demand forecasts 414. For example, the nearest neighbor item forecast may output the demand forecast 414 to the forecast consumer 122. As another example, the nearest neighbor item forecast may output the demand forecasts 414 to a database. As illustrated by FIG. 4, the forecasting models 216 may also output demand forecasts 416. In some embodiments, the output from the nearest neighbor item forecast may have a common format as the output from the forecasting models 216. For example, the forecasts 414 and 416 may be tables with a common schema.

FIG. 5 is a flowchart of an example method 500. One or more operations of the method 500 may be executed to perform aspects of applying the nearest neighbor item forecast 316. As described herein, the method 500 may be performed by the forecasting system 102. However, one or more other components may also perform aspects of the method 500. In some embodiments, the method 500 may include more or fewer operations than those described herein, the order in which the operations are performed may vary, and one or more operations may be repeated. As described in connection with FIG. 4, the nearest neighbor item forecast may receive a plurality of inputs, including one or more of a forecast universe, similar item mappings, existing forecasts, and item prices.

In the example shown, the forecasting system 102 may select an item to forecast from a plurality of items that are eligible for the nearest neighbor item forecast (step 502). Depending on the embodiment, a definition of eligibility for the nearest neighbor item forecast may vary. For example, the forecasting system 102 may determine that the forecasting models 216 may not be able to generate a demand forecast for a plurality of items. Such items may be eligible for the nearest neighbor item forecast, and the forecasting system 102 may select one of these items. In some embodiments, the items eligible for the nearest neighbor item forecast may include new items or items with little historical demand data.

In some embodiments, the nearest neighbor item forecast may be applied to items for which a forecasting model cannot be trained to generate a demand forecast due to data scarcity (e.g., due to a lack of training data associated with the items). This data scarcity may be caused by a lack of historical demand data associated with the items. For example, the forecasting system 102 may determine that a number of available training instances associated with an item is below a number required to train a model to a sufficient degree of accuracy (e.g., the amount of data may be below a threshold amount of data required to sufficiently train the model). As another example, the forecasting model 102 may determine that the quality (e.g., diversity) of the training data is insufficient to train a model to the sufficient degree of accuracy. In some embodiments, the nearest neighbor item forecasts may be applied to items for which existing forecasting models are unable to generate a forecast for other reasons (e.g., items for which an error is generated). In some embodiments, the nearest neighbor forecast may provide a validation to other forecasting models, or the nearest neighbor forecast may be part of an ensemble of forecasting models.

In some embodiments, the forecasting system 102 may select a plurality of items for applying the nearest neighbor forecast, thereby generating a plurality of nearest neighbor item forecasts as a batch. In some embodiments, the forecasting system 102 may repeat the method 500 to apply the nearest neighbor item forecast, wherein each iteration of the method 500 may include a selection of a different item from the items that are eligible for the nearest neighbor item forecasts. In some embodiments, the forecasting system 102 may also determine a type of forecast to generate for the selected item. For example, the forecasting system may select whether to determine a location-specific item forecast or an overall item forecast. In some embodiments, the forecasting system 102 may determine a time for which to generate a forecast. The time may be an amount of time from a current time (e.g., a demand forecast for the next week, month, or year), or the time may be a range in the future (e.g., a demand forecast between August 1st to August 15th).

In the example shown, the forecasting system 102 may determine a set of items to evaluate for similarity with the selected item (step 504). For example, from a universe of items, a subset of items may be determined. The forecasting system 102 may evaluate the similarity of the selected item with the items in this subset of items. In some embodiments, the set of items to evaluate for similarity includes items for which a forecasting model successfully generated a forecast. In some embodiments, determining the subset of items may include applying an item attribute or category filter to the universe of items. In some embodiments, determining the subset of items may include excluding items from universe of items, such as items that are sufficiently dissimilar to the selected item.

In the example shown, the forecasting system 102 may determine a set of similar items to the selected item. For example, the forecasting system 102 may apply the similarity scoring system 204 to determine a similarity score between the selected item and the items to which the selected item is to be compared. In some embodiments, the set of similar items may only include items with similarity scores above a threshold. For example, for a given item, the forecasting system 102 may determine the similarity score between the given item and the selected item, and then the forecasting system 102 may determine whether the similarity score is above a pre-determined threshold. If so, the item may be included in the set of similar items. If not, the item may be excluded. In some embodiments, the threshold is set by the administrator 120. In some embodiments, the threshold varies from one item to the next. For example, a relatively high similarity threshold may be set for items in a category with many items whereas a relatively low similarity threshold may be set for items in a category with relatively few items.

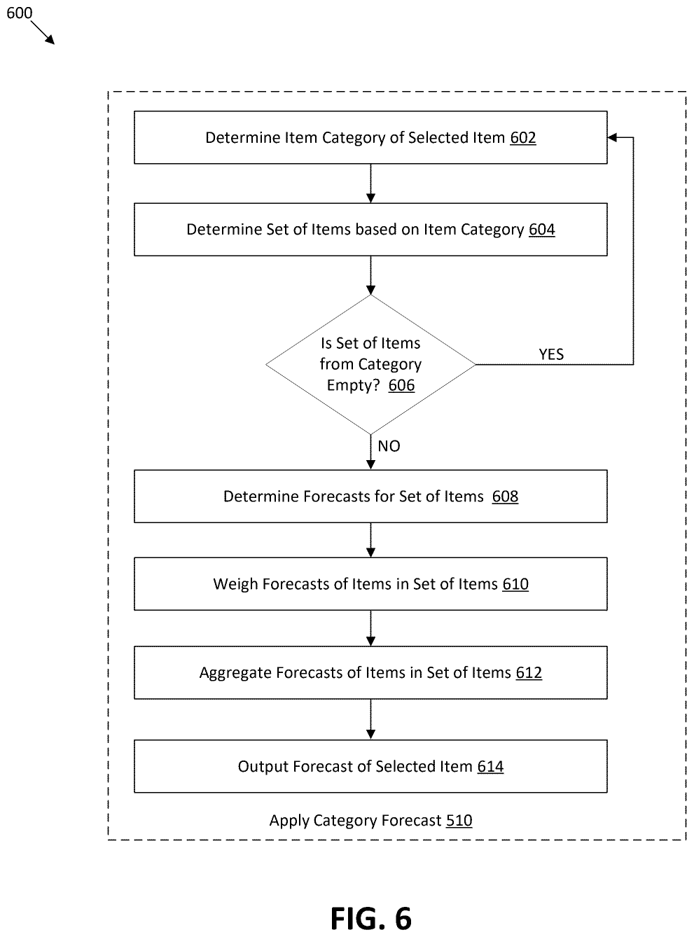

In the example shown, the forecasting system 102 may determine whether the set of similar items is empty (step 508). In response to determining that the set of similar items is empty (e.g., taking the “YES” branch), the forecasting system 102 may apply a category forecast to determine a demand forecast for the selected item (step 510). According to a category forecast, the forecasting system 102 may determine a forecast based on items in a common category as the selected item. Example aspects of a category forecast are further described below in connection with FIG. 6. In response to determining that the set of similar items is not empty (e.g., taking the “NO” branch), the forecasting system 102 may rank similar items.

In some embodiments, rather than determining whether the set is empty, the forecasting system 102 may compare a size of the set to a threshold number (e.g., 4). If the size of the set is greater than or equal to the threshold number, the forecasting system 102 may proceed to the step 512. If not, the forecasting system 102 may proceed to the step 510.

In the example shown, the forecasting system 102 may rank similar items (step 512). For example, the forecasting system 102 may rank items in the set of similar items determined at the step 506. In some embodiments, the forecasting system 102 may rank the items based on descending similarity scores, where the item with the highest similarity score is ranked first.

In the example shown, the forecasting system 102 may determine forecasts of similar items (step 514). For example, the forecasting system 102 may, for each of the items in the set of similar items to the selected item, apply one or more of the forecasting models 216 to the item. In some embodiments, the forecasting system 102 may retrieve the demand forecasts for the similar items from the existing forecasts 410. The forecasts for the similar items may depend on the type of forecast being generated for the selected item. For example, if the forecast for the selected item is an overall forecast for a certain time period, then the forecasts for the similar items may likewise be an overall forecast for that time period.

In the example shown, the forecasting system 102 may weigh forecasts of similar items (step 516). For example, for a given similar item, the forecasting system 102 may weigh the forecast of that item to account for differences between that item and the selected item. As one example, the forecasting system 102 may weigh the forecast to account for price differences. For example, if the price of the similar item is greater than the price of the selected item, then the demand forecast may be increased (e.g., multiplied by a number greater than 1) to account for the effect that the similar item's higher price may have on its demand. Conversely, if the price of the similar item is less than the price of the selected item, then the demand forecast may be decreased (e.g., multiplied by a number between 0 and 1) to account for the effect that the similar item's lower price may have on it demand.

The example equation (1) illustrates an example price adjustment that may be applied by the forecasting system 102:

$${F}^{{A}_{j}} ( A ) = {f}^{{pr}_{A}} ( {pr}_{{A}_{j}} ) \times F ( {A}_{j} ) \qquad ( 1 )$$

In the example of equation (1), A may represent the selected item, Aⱼ may represent a similar item to the selected item, F(Aⱼ) may represent a demand forecast for Aⱼ, f^{pr}(pr_{Aj}) may represent a price adjustment function based on a difference between the prices of A and Aⱼ, and F^{Aj}(A) represents a contribution of the item Aⱼ to the demand forecast for A.

As another example of weighing the forecasts of similar items, the forecasting system 102 may adjust the demand forecast of a similar item based on its degree of similarity with the selected item. For example, the more similar that an item is to the selected item, the greater weight its forecast may have as part of determining the forecast of the selected item. For example, for each similar item in the set of items similar to the selected item, the forecasting system 102 may multiply the forecast for the similar item by the similarity score determined by the similarity scoring system 204. In some embodiments, the forecasting system 102 may weigh the price-adjusted forecast of a similar item based on the item's degree of similarity with the selected item.

In the example shown, the forecasting system 102 may aggregate the forecasts of similar items (step 518). In some embodiments, aggregating the forecasts of similar items may include adding them. In some embodiments, aggregating the forecasts of similar items may include adding the weighted forecasts (e.g., weighted based on one or more of price differences or degree of similarity).

The example equation (2) illustrates an example of aggregating forecasts of similar items that may be applied by the forecasting system 102:

$$F ( A ) = {\sum }_{{A}_{j} ∈ {S}_{A}} {λ}_{j}^{A} {F}^{{A}_{j}} ( A ) \qquad ( 2 )$$

In the example of equation (2), F(A) may represent the nearest neighbor forecast for the selected item A, Aₛ may represent a set of similar items to the item A, λⱼ^{A} may represent a similarity-based weight applied for a similar item Aⱼ, and F^{Aj}(A) may represent a price-adjusted contribution to the forecast of item A based on the forecast for the item Aj, as is described in connection with the equation (1).

In the example shown, the forecasting system 102 may output the forecast for the selected item. For example, the forecasting system 102 may output the result of F(A) from the example equation (2). In some embodiments, the forecasting system 102 may output the forecast to a forecast consumer or to a database of forecasts. In some embodiments, the forecast may be automatically received by the forecast consumer, thereby causing an inventory change based on data of the demand forecast. In some embodiments, the forecasting system 102 may repeat aspects of the method 500 to generate a plurality of forecasts for the selected item (e.g., forecasts for different locations, forecasts for an overall demand, forecasts for different time periods, forecasts subject to different hypothetical conditions, such as a price promotion, or other forecast for the selected item), and the forecasting system 102 may output the plurality of forecasts for the selected item as a batch or table. In some embodiments, the forecasting system 102 may repeat aspects of the method 500 to generate demand forecasts for other items, and the forecasting system 102 may output the demand forecast for these other items along with demand forecast for the selected item.

FIG. 6 is a flowchart of an example method 600. One or more operations of the method 600 may be executed to perform aspects of applying the category forecast (e.g., the step 510 of FIG. 5). As described herein, the method 600 may be performed by the forecasting system 102. However, one or more other components may also perform aspects of the method 600. In some embodiments, the method 600 may include more or fewer operations than those described herein, the order in which the operations are performed may vary, and one or more operations may be repeated.

In some embodiments, the forecasting system 102 may apply the category forecast after performing operations of the method 500. For example, the forecasting system 102 may select an item for which to generate a demand forecast. The forecasting system 102 may determine items similar items. In response to failing to identify items that are sufficiently similar to the selected item, the forecasting system 102 may apply the category forecast to forecast demand for the selected item. In some embodiments, the forecasting system 102 may apply the category forecast to determine an overall forecast for the selected item or may apply the category forecast to determine one or more location-specific forecasts for the item. The forecasting system 102 may apply the category forecast to determine forecasts for one or more time periods. The forecasting system 102 may apply the category forecast to a plurality of items.

In the example shown, the forecasting system 102 may determine a category of the selected item (step 602). In some embodiments, an item may have various associated categories. In some embodiments, the categories may correspond to categories of a retailer. In some embodiments, the categories may be sets of items, and the categories for an item may include a series of sets that increase in size and that include all items of previous sets. As an example, the selected item may be 12 oz. Brand X Peanut Butter. A first category of this item may be “Peanut Butter,” a second category of this item may be “Pantry,” and a third category of this item may be “Grocery.” In some embodiments, the categories for an item may account for the channel or location at which the item is sold. As another example, the selected item may be online orders for baby socks. The first category for this item may be online baby clothes, the second category may be online apparel, and the third category may be all apparel.

In some embodiments, when determining an item category for the selected item, the forecasting system 102 may select the smallest category that has not yet been evaluated for the selected item. For instance, during a first iteration of the method 600, the forecasting system 102 may select the first category for the selected item. For example, referring again to the example in which the item is 12 oz. Brand X Peanut Butter, the forecasting system 102 may select the category “Peanut Butter.”

In the example shown, the forecasting system 102 may determine a set of items from the item category (step 604). For example, the forecasting system 102 may identify other items that have a first category of “Peanut Butter.” In some embodiments, the forecasting system 102 may consider only a subset of all potential items to identify the set of items. For example, as described above in connection with the operations of 504-506, the set of items may include items for which the forecasting models 216 successfully generated a demand forecast.

In the example shown, the forecasting system 102 may determine whether the set of items from the category is empty (step 606). For example, the forecasting system 102 may determine whether the set of items determined at the step 604 is an empty set. In response to determining that the set of items is empty (e.g., taking the “YES” branch), the forecasting system 102 may return to the step 602. At the step 602, the forecasting system 102 may select a different category of the item. For example, the forecasting system 102 may select the next smallest category of the selected item that has not yet been evaluated. For example, in the peanut butter, the forecasting system 102 may select the category “Pantry.”

In response to determining that the set of items is not empty (e.g., taking the “NO” branch), the forecasting system 102 may proceed to the step 608. In some embodiments, rather than determining whether the set is empty, the forecasting system 102 may compare a size of the set to a threshold number (e.g., 4). If the size of the set is greater than or equal to the threshold number, the forecasting system 102 may proceed to the step 608. If not, the forecasting system 102 may return to the step 602.

In the example shown, the forecasting system 102 may determine forecasts for items in the set of items (step 608). For example, the forecasting system 102 may apply one or more of the models 216 to generate a demand forecast for each item in the set of items.

In the example shown, the forecasting system 102 may weigh forecast of items in the set of items (step 610). For example, the forecasting system 102 may apply a price adjustment to one or more of the forecasts of the items of the set of items, an example of which is described above in connection with FIG. 5. As another example, the forecasting system 102 may weigh the forecasts based on a similarity with the selected item, an example of which is described above in connection with FIG. 5. In some embodiments, items of the set may be weighed equally. For example, a forecast associated with each of the items may be multiplied by one over the size of the set.

In the example shown, the forecasting system 102 may aggregate the forecasts of items in the set of items (step 612). In some embodiments, aggregating the forecasts of items in the set of items includes adding them. In some embodiments, aggregating the forecasts of the items may include adding weighted forecasts (e.g., weighted based on one or more of price differences, degree of similarity, or normalization weight).

In the example shown, the forecasting system 102 may output the forecast for the selected item. In some embodiments, the forecasting system 102 may repeat aspects of the method 600 to generate a plurality of forecasts for the selected item (e.g., forecasts for different locations, forecasts for an overall demand, forecasts for different time periods, forecasts subject to different hypothetical conditions, such as a price promotion, or other forecast for the selected item), and the forecasting system 102 may output the plurality of forecasts for the selected item as a batch or table. In some embodiments, the forecasting system 102 may repeat aspects of the method 600 to generate demand forecasts for other items, and the forecasting system 102 may output the demand forecast for these other items along with demand forecast for the selected item.

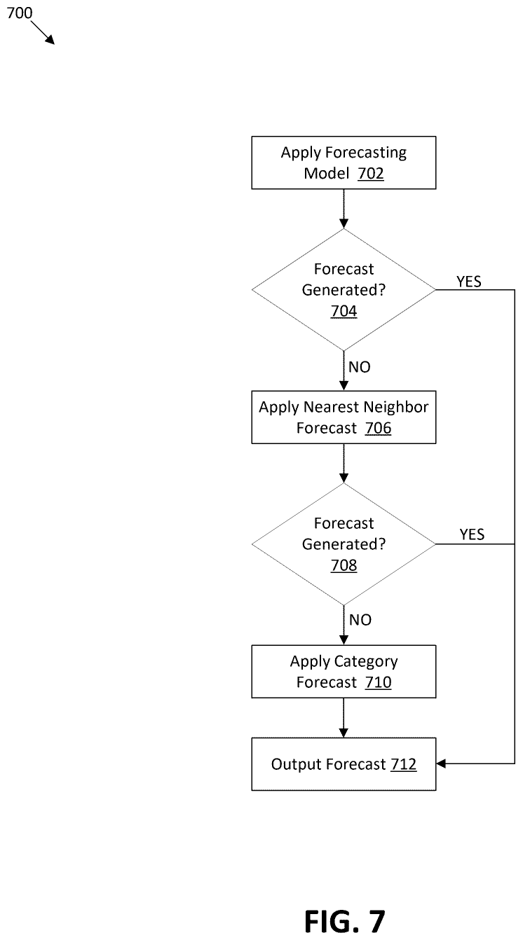

FIG. 7 is a flowchart of an example method 700. The forecasting system 102 may apply aspects of the method 700 to generate a demand forecast of an item. For example, the forecasting system 102 may apply the method 700 to generate a demand forecast for an item selected from a plurality of items for which to generate a forecast. According to the example of FIG. 7, when generating a demand forecast for the selected item, forecasting system 102 may give priority to the forecasting models 216, followed by the nearest neighbor item forecast, followed by the category forecast. In some embodiments, the forecasting system 102 may apply the method 700 to generate a location-specific demand forecast or an overall demand forecast. In some embodiments, one or more other components may also perform aspects of the method 700. In some embodiments, the method 700 may include more or fewer operations than those described herein, the order in which the operations are performed may vary, and one or more operations may be repeated.

In the example shown, the forecasting system 102 may apply a forecasting model (step 702). For example, the forecasting system 102 may apply one or more of the forecasting models 216 to generate a demand forecast for a selected item. In some instances, the forecasting system 102 may successfully generate a demand forecast for the selected item using the forecasting models 216. For example, there may be sufficient training data related to the selected item, such as historical sales data. As a result, the forecasting models 216 may be configured to generate a demand forecast for the selected item. In some instances, however, the forecasting models 216 may be unable to generate a demand forecast for the selected item. For example, the forecasting system 102 may identify a lack of historical demand data associated with the selected item, such as insufficient historical sales data. Due to this data scarcity, the forecasting models 216 may not, in some instances, be configured to generate a demand forecast.

In the example shown, the forecasting system 102 may determine whether a forecast is generated (step 704). For example, the forecasting system 102 may determine whether the forecasting models 216 successfully generated a demand forecast for the selected item. In some embodiments, the forecasting models 216 may output an error flag or message if unable to generate a demand forecast. In some embodiments, the forecasting system 102 may evaluate a confidence metric or other data to evaluate whether the forecasting models 216 successfully generated a demand forecast. In some embodiments, the forecasting system 102 may identify that a forecasting model does not exist for the selected item. In some embodiments, the forecasting system 102 may determine that a forecasting model is not trained using demand data associated with the selected item. In response to determining that a forecast was successfully generated (e.g., taking the “YES” branch), the forecasting system 102 may proceed to output the generated forecast (step 712). In response to determining that a forecast was not successfully generated (e.g., taking the “NO” branch), the forecasting system 102 may proceed to the step 706.

In the example shown, the forecasting system 102 may apply a nearest neighbor forecast to generate a demand forecast for the selected item (step 706). Example aspects of applying a nearest neighbor item forecast are described above in connection with FIG. 4-5. Applying the nearest neighbor forecast may include determining a set of similar items to the selected item (e.g., based on a similarity score being greater than a threshold value, as described above). In some embodiments, if the set of similar items is empty or is below a required number, then the forecasting system 102 may be unable to generate a nearest neighbor forecast for the selected item. If, on the other hand, the set of similar items is not empty or includes a number of items greater than then the required number, the forecasting system 102 may be able to generate a demand forecast using the nearest neighbor forecast.

In the example shown, the forecasting system 102 may determine whether a forecast was successfully generated using the nearest neighbor forecast (step 708). In response to determining that a forecast was successfully generated (e.g., taking the “YES” branch), the forecasting system 102 may output the generated forecast (step 712). In response to determining that a forecast was not generated using the nearest neighbor forecast (e.g., taking the “NO” branch), the forecasting system 102 may proceed to the step 710.

In the example shown, the forecasting system 102 may apply the category forecast to generate a demand forecast for the selected item (step 710). Example aspects of applying the category forecast are described above in connection with FIG. 6.

In the example shown, the forecasting system may output the forecast for the selected item (step 712). Advantageously, the example of FIG. 7 illustrates that the forecasting system 102 may, in some embodiments, attempt various techniques to generate a demand forecast for a selected item. For example, if there is sufficient training data for existing models to generate a demand forecast for the item, then the forecasting system 102 may use existing models; if not, the forecasting system 102 may generate a demand forecast using an aggregation of model-based demand forecasts of similar items; if there are an insufficient number of similar items, then the forecasting system 102 may generate a demand forecast for the selected item using an aggregation of model-based demand forecasts of items belonging to a common category as the selected item.

FIG. 8 illustrates an example user interface 800. The example user interface 800 may be a graphical user interface that is part of the forecast consumer 122 or that is provided to the forecast consumer 122. As an example, the user interface 800 may be displayed as part of a web application. Via the user interface 800, a user may interact with the forecasting system 102. For example, via the user interface 800, a user may provide inputs to the forecasting system 102 to generate a demand forecast. Furthermore, via the user interface 800, the user may receive data, such as demand forecasts or data related to generating a demand forecast. In some embodiments, functions of the forecasting system 102 that may be provided via the user interface 800 may be exposed as part of an API to the forecast consumer 122. Depending on the embodiment, the user interface 800 may include more or fewer components than those depicted in connection with FIG. 8. Furthermore, the arrangement and function of the components may vary. Furthermore, the forecasting system 102 may include more user interfaces than the user interface 800.

In the example shown, the user interface 800 includes a plurality of inputs field 802-814. The input fields may be graphical user interface elements via which a user may input data. Examples may include text input fields, drop-down menus, radio buttons, or other input fields. Each input field may comprise a plurality of input fields. In some embodiments, a user may provide data corresponding to an input field via touch or voice. In some embodiments, the input that may be provided via an input field may depend on an input received at another input field. For example, depending on one or more of a time period or item that is selected, the options in one or more of the model selection or similarity scorer selection may vary.

Via the item selection input field 802, the forecasting system 102 may receive a selection of one or more items for which to generate a demand forecast. In some embodiments, the item selection input field 802 may provide a catalog of items from which to select, such as a catalog of items offered by a retailer. In some embodiments, the user may select a group of items.

Via the time selection input field 804, the forecasting system 102 may receive one or more time periods for which to generate a demand forecast. For example, the user may select a range of times, an amount of time from a current time (e.g., a demand forecast for current fiscal year), or another indication of time.

Via the location selection input field 806, the forecasting system 102 may receive one or more locations. For example, the user may input a selection of one or more of the retail locations 104 for which to generate a demand forecast. In some embodiments, the user may select to generate an overall demand forecast, which may include all locations.

Via the model selection input field 808, the forecasting system 102 may receive a selection of one or more of the forecasting models 216. In some embodiments, the forecasting system 102 may prioritize the selected model for generating a demand forecast of the selected item. However, as described above, the selected model may not be configured to generate a demand forecast for the selected item (e.g., due to a lack of training data). In some embodiments, the forecasting system 102 may nevertheless use the selected model to generate demand forecasts for items that are similar to the selected item or that belong to a common category as the selected item.

Via the similarity scorer input field 810, the forecasting system 102 may receive a selection corresponding to the similarity scoring system 204. For example, the user may select one or more of a plurality of techniques that may be deployed by the forecasting system 102 to evaluate item similarity. Furthermore, the forecasting system 102 may receive a selection of parameters to use for evaluating similarity. For instance, if a system that evaluates the similarity of item attributes is used, then the forecasting system 102 may receive a selection of which attributes to evaluate. As another example, the forecasting system 102 may receive an input corresponding to identifying similar sales patterns.

Via the select filter input field 812, the forecasting system 102 may receive a selection of one or more filters to apply to items. For example, the forecasting system 102 may apply the filters to a full catalog of items to narrow down the set of items for which to generate a demand forecast or to evaluate as part of determining similar items. In some embodiments, the filters may relate to item sales patterns (e.g., fast-selling items, seasonal items, promotion items, etc.) or to item attributes.

The set parameters input fields 814 may include a one or more input fields for setting parameters of the forecasting system 102 or setting parameters of one or more components of the forecasting system 102.

The options 816 may include a plurality of options for performing operations that may be provided by the forecasting system 102. In some embodiments, in response to receiving a selection of one of the options 816, the forecasting system 102 may perform a corresponding operation using data input via the input fields 802-814.

For example, the forecasting system 102 may forecast demand for a selected item. As part of doing so, the forecasting system 102 may generate data for other aspects of the user interface 800, such as the forecast visualization 818, the forecast data 820, and the similar item data 822. As another example, the forecasting system 102 may export forecasting data to other systems, such as a supply chain or inventory management system. As another example, the forecasting system 102 may validate a forecast. For example, the forecasting system 102 may apply aspects of the validation tool 240 to identify errors in a forecast, to identify a confidence of a forecast, or to provide results of past demand forecasts. As another example, the forecasting system 102 may apply a hypothetical to a demand forecast. For example, after receiving a selection to apply a hypothetical scenario, the forecasting system 102 may further receive data related to the hypothetical scenario. For example, the forecasting system 102 may receive data corresponding to a price change, promotion, a change to inventory assortment, or another scenario. In such a situation, the forecasting system 102 may generate a demand forecast according to the input hypothetical data.

The visualization 818 may include data related to a forecast generated by the forecasting system 102. For example, the visualization 818 may include forecasted demand for one or more items over item. The visualization 818 may be one or more of a graph, table, chart, or other visualizations. In some embodiments, the visualization 818 may be interactive. For example, a user may select a display in the visualization 818 to view additional data (e.g., a forecasted demand for a selected item at a selected time).

The demand forecast data 820 may include data related to a forecast generated by the forecasting system 102. In the example, shown, the demand forecast data 820 includes a forecasting method that was used. For instance, the forecasting method used may have been the nearest neighbor forecast. For example, for the selected item, an existing model may have failed to generate a demand forecast, and the forecasting system 102 may have applied the nearest neighbor forecast. In the example shown, the demand forecast data 820 further includes a forecasting model that was used (e.g., GAMM). For instance, the forecasting model may have been used to determine forecasts of items similar to the selected item. The demand forecast data 820 further includes a demand forecast over time (e.g., a demand forecast at each of a plurality of weeks).

The similar item data 822 may include data related to one or more items that are similar to a selected item. In some embodiments, the similar item data 822 includes data for one or more items used to generate a nearest neighbor forecast for the selected item. In the example shown, the similar item data 822 may include an item identifier, a demand (e.g., a model-based forecasted demand), a similarity score between the item and the selected item, and a forecast adjustment (e.g., a price adjustment).

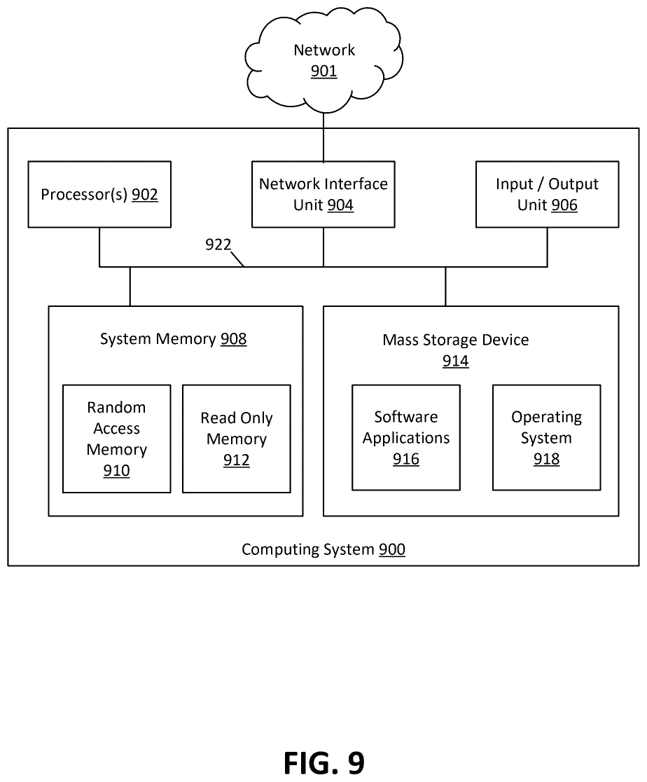

FIG. 9 illustrates an example block diagram of a virtual or physical computing system 900. One or more aspects of the computing system 900 can be used to implement the system and processes described herein.

In the embodiment shown, the computing system 900 includes one or more processors 902, a system memory 908, and a system bus 922 that couples the system memory 908 to the one or more processors 902. The system memory 908 includes RAM (Random Access Memory) 910 and ROM (Read-Only Memory) 912. A basic input/output system that contains the basic routines that help to transfer information between elements within the computing system 900, such as during startup, is stored in the ROM 912. The computing system 900 further includes a mass storage device 914. The mass storage device 914 is able to store software instructions and data. The one or more processors 902 can be one or more central processing units or other processors.

The mass storage device 914 is connected to the one or more processors 902 through a mass storage controller (not shown) connected to the system bus 922. The mass storage device 914 and its associated computer-readable data storage media provide non-volatile, non-transitory storage for the computing system 900. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 900.

According to various embodiments of the invention, the computing system 900 may operate in a networked environment using logical connections to remote network devices through the network 901. The network 901 is a computer network, such as an enterprise intranet and/or the Internet. The network 901 can include a LAN, a Wide Area Network (WAN), the internet, wireless transmission mediums, wired transmission mediums, other networks, and combinations thereof. The computing system 900 may connect to the network 901 through a network interface unit 904 connected to the system bus 922. It should be appreciated that the network interface unit 904 may also be utilized to connect to other types of networks and remote computing systems. The computing system 900 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the computing system 900 can store software instructions and data. The software instructions include an operating system 918 suitable for controlling the operation of the computing system 900. The mass storage device 914 and/or the RAM 910 also store software instructions, that when executed by the one or more processors 902, cause one or more of the systems, devices, or components described herein to provide functionality described herein. For example, the mass storage device 914 and/or the RAM 910 can store software instructions that, when executed by the one or more processors 902, cause the computing system 900 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A method for forecasting demand, the method comprising:
determining that a forecasting model is unable to generate a demand forecast for a selected item based at least in part on a lack of training data associated with the selected item;
determining a set of similar items for the selected item;
for each similar item in the set of similar items, applying the forecasting model to determine a respective demand forecast for the similar item; and
determining the demand forecast for the selected item by aggregating respective demand forecasts of similar items of the sets of similar items.

2. The method of claim 1, wherein determining that the forecasting model is unable to generate the demand forecast for the selected item based at least in part on the lack of training data associated with the selected item comprises determining that an amount of historical demand data associated with the selected item is below a threshold amount.

3. The method of claim 1,
wherein the forecasting model includes a plurality of models; and
wherein determining that the forecasting model is unable to generate the demand forecast for the selected item comprises determining that the plurality of models do not include a model configured to generate the demand forecast for the selected item.

4. The method of claim 1, wherein the forecasting model is a machine learning model.

5. The method of claim 1, wherein aggregating the respective demand forecasts of the similar item of the set of similar items comprises weighing each of the respective demand forecasts based on one or more of a similarity score or a price adjustment.

6. The method of claim 1, wherein determining the set of similar items for the selected item comprises:
determining a plurality of items to evaluate;
for each item to evaluate, determine a similarity score between the item and the selected item; and
for each item to evaluate, add the item to the set of similar items in response to determining that the similarity score is greater than a threshold.

7. The method of claim 6, wherein determining the similarity score comprises determining the similarity score based on a comparison of item embeddings.

8. The method of claim 6, wherein determining the similarity score comprises determining the similarity score based on a demand patterns.

9. The method of claim 1, further comprising:
determining a second demand forecast for a second selected item by applying the forecasting model, wherein the forecasting model has sufficient training data associated with the second item; and
outputting the demand forecast and the second demand forecast to a forecast consumer.

10. The method of claim 9, further comprising:
determining that the forecasting model is unable to generate a third demand forecast for a third selected item;
determining a second set of similar items for the third selected item;
determining that a size of the second set of similar items is lower than a threshold size;
determining the third demand forecast for the third selected item by applying a category forecast; and
outputting the third demand forecast to the forecast consumer.

11. The method of claim 1, further comprises outputting the demand forecast to a forecast consumer in a common format as an output of the forecasting model.

12. The method of claim 1, wherein the selected item is a new item.

13. The method of claim 1, wherein the demand forecast for the selected item corresponds to one or more locations or an overall demand forecast.

14. The method of claim 1, further comprising:
receiving a selection of the selected item via a graphical user interface;
receiving a selection of the forecasting model via the graphical user interface; and
outputting a visualization of the demand forecast to the graphical user interface.

15. The method of claim 1,
wherein the selected item is offered for sale by a retailer;
wherein each similar item of the set of similar items is offered for sale by the retailer; and
wherein each similar item of the set of similar items is associated with historical demand data.

16. A forecasting system comprising:
a similarity scoring system;
a forecasting model; and
an orchestrator;
wherein the orchestrator is configured to:
determine, for a selected item, whether the forecasting model is configured to generate a demand forecast for the selected item;
in response to determining that the forecasting model is not configured to generate the demand forecast for the selected item based on a lack of training data associated with the selected item, determine a set of similar items for the selected item by using the similarity scoring system;
for each similar item in the set of similar items, apply the forecasting model to determine a respective demand forecast for the similar item; and
determine the demand forecast for the selected item by aggregating respective demand forecasts of similar items of the set of similar items.

17. The forecasting system of claim 16, further comprising a validation tool configured to identify a difference between the demand forecast and an actual demand.

18. The forecasting system of claim 16,
further comprising a catalog of items;
wherein each of the selected item and the similar items belong to the catalog of items.

19. The forecasting system of claim 16,
wherein determining that the forecasting model is not configured to generate the demand forecast for the selected item comprises identifying a lack of historical demand data associated with the selected item; and
wherein aggregating the respective demand forecasts of the similar items of the set of similar items comprises weighing the respective demand forecasts based on one or more of a similarity score or a price adjustment.

20. A demand forecasting tool comprising:
a processor; and
memory storing instructions that, when executed by the processor, cause the demand forecasting tool to:
determine that a forecasting model is unable to generate a demand forecast for a selected item based at least in part on a lack of training data associated with the selected item;
determine a set of similar items for the selected item;
for each similar item in the set of similar items, apply the forecasting model to determine a respective demand forecast for the similar item; and
determine the demand forecast for the selected item by aggregating respective demand forecasts of similar items of the sets of similar items.
